(19) United States
(12) Patent Application Publication
(10) Pub. No.: US 2006/0245381 A1
(43) Pub. Date: Nov. 2, 2006

(54) Data communication system

(75) Inventors: Donald Baxter, Stirling (GB); Brian Laffoley, Fife (GB); J. E.D. Hurwitz, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Limited, Marlow - Buckinghamshire (GB)

(21) Appl. No.: 11/303,638

(22) Filed: Dec. 16, 2005

(30) Foreign Application Priority Data
Dec. 16, 2004 (EP) 04257853.4

(51) Int. Cl. H04L 5/16

(52) U.S. Cl. 370/296

(57) ABSTRACT

The data communication system includes a first control device, a second data device and a data link, including a first transmission link and a second transmission link, between the second data device and the first control device. A data driver enables data transmission from the second data device to the first control device across the data link, and a differential controller is adapted to generate a voltage differential between the first transmission link and the second transmission link. A detector detects differences in voltage levels between the first transmission link and the second transmission link. The data communication system enables bi-directional communication between integrated circuit devices over a serial communication link avoiding the necessity for clock, chip enable and control connections on the data device and is particularly useful for communication between an image sensor and coprocessor.

### FIELD OF THE INVENTION

The present invention relates to a system for data communication and particularly, to a system for data communication between integrated circuit (IC) devices using differential common mode signaling.

### BACKGROUND OF THE INVENTION

A typical prior art image sensor IC device requires at least eight electrical connectors or pins. The image sensor requires a coprocessor to form a complete imaging system. Referring to FIG. 1, a prior art image system 10 includes an image sensor 12 and a coprocessor 14. The system 10 has power down control line PDN and a system clock line CLK both of which are connected to both the image sensor 12 and the coprocessor 14.

The image sensor 12 and the coprocessor 14 communicate control commands over a private I²C (Inter-Integrated Circuit) bus having a I²C clock line MSCL and I²C data line MSDA, where the coprocessor 12 is the bus master and the image sensor 10 is a single slave. Data, in the form of pixel values, from the image sensor 10 is communicated over serial differential data lines PDATAP and PDATAN in conjunction with serial clock qualification lines PCLKP and PCLKN. The clock lines PCLKP and PCLKN enable the coprocessor 14 to synchronize correctly with the data communicated on the data lines PDATAP and PDATAN.

Advances in technology have driven integrated circuits down in size dramatically. In some cases, the IC device size is limited, not by the IC itself, but by the space required to enable the number of connectors or pins to be attached to the IC. Prior art solutions to reduce the number of pins have a significant protocol and/or transmission/reception implementation cost. For example, duplex links are available, where the transmitted signal has to be filtered out of the received signal before it can be used. Another example of prior art is a half duplex link, were the link is used one way for a time and then the other for some time. However, half duplex systems suffer when there is little down time of data traveling in one direction in which data can be transmitted the other way. Time, as well as other issues, cause this approach to be technically difficult.

### SUMMARY OF THE INVENTION

According to the present invention there is provided a data communication system including a first control device, a second data device, and a communication link, comprising a first transmission link and a second transmission link, between the second data device and the first control device. A data driver enables data transmission from the second data device to the first control device across the communication link, and a differential controller is adapted to generate a voltage differential between the first transmission link and the second transmission link. A detector is enabled to detect differences in voltage levels between the first transmission link and the second transmission link.

The detector is any suitably connected arrangement to differentiate voltage levels between the first transmission link and the second transmission link. Preferably, the first control device receives an external clock signal and the differential controller varies the voltage differential between the first transmission link and the second transmission link such that the external clock signal is transmitted to the second data device as an internal clock signal.

Preferably, the differential controller is enabled to vary the duty cycle of the transmission of the internal clock signal to represent a data signal from the first control device to the second data device. Preferably, the detector comprises a clock detector and a data detector. Preferably, the second data device further comprises a phase lock loop, the phase lock loop receiving the internal clock signal from the clock detector. Preferably, the phase lock loop locks to the positive edges of the internal clock signal.

Preferably, the first transmission link comprises a first data line and a second data line and the second transmission link comprises a first clock line and a second clock line, the first and second transmission links thereby forming a serial data link from the second data device to the first control device, the first transmission link thereby having a first common mode voltage and the second transmission link having a second common mode voltage. Preferably, the second data device further comprises a filter, the filter filtering the internal clock signal and enabling the data signal to be extracted from the internal clock signal to produce a filtered data signal.

Preferably, the filter comprises an analog filter, an over-sampler and a digital filter, the data signal first being passed to the analog filter before being over-sampled by the over-sampler and finally digitally filtered by the digital filter to produce the filtered data signal. Preferably, the second data device is enabled and/or disabled by setting the first and the second transmission links to ground or to high. Preferably, a device enable detector detects that the first and the second transmission links are set to ground, or to high, and enables or disables the second data device.

According to a second aspect of the present invention there is provided an optical pointing device comprising a data communication system according to the first aspect of the invention. Preferably, the optical pointing device is an optical mouse.

According to a third aspect of the present invention there is provided a mobile device comprising a data communication system according to the first aspect of the invention. Preferably, the mobile device is a mobile cellular telephone or a camera.

### BRIEF DESCRIPTION OF THE DRAWINGS

Embodiments of the present invention will now be described with reference to the accompanying drawings, in which:

FIG. 1 is a block diagram illustrating a prior art data communication system between devices.

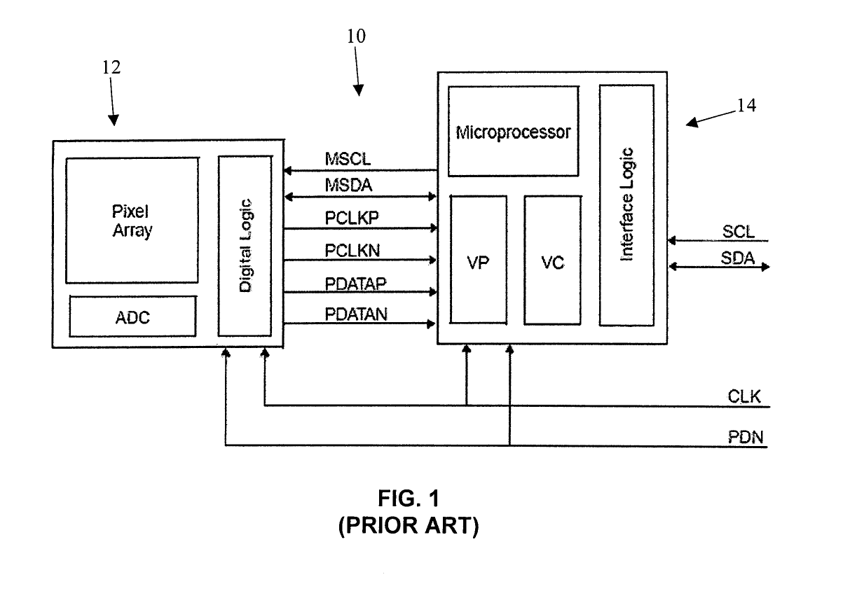

FIG. 2 is a schematic diagram illustrating an embodiment of a data communication system according to the present invention;

FIG. 3 is a timing diagram illustrating encoding of a data signal according to an embodiment of the present invention;

FIG. 4 is a timing diagram illustrating filtering of a data signal according to an embodiment of the present invention; and

FIG. 5 is a graph illustrating traces of a data communication link, a clock communication link and a control communication link.

### DETAILED DESCRIPTION OF THE PREFERRED EMBODIMENTS

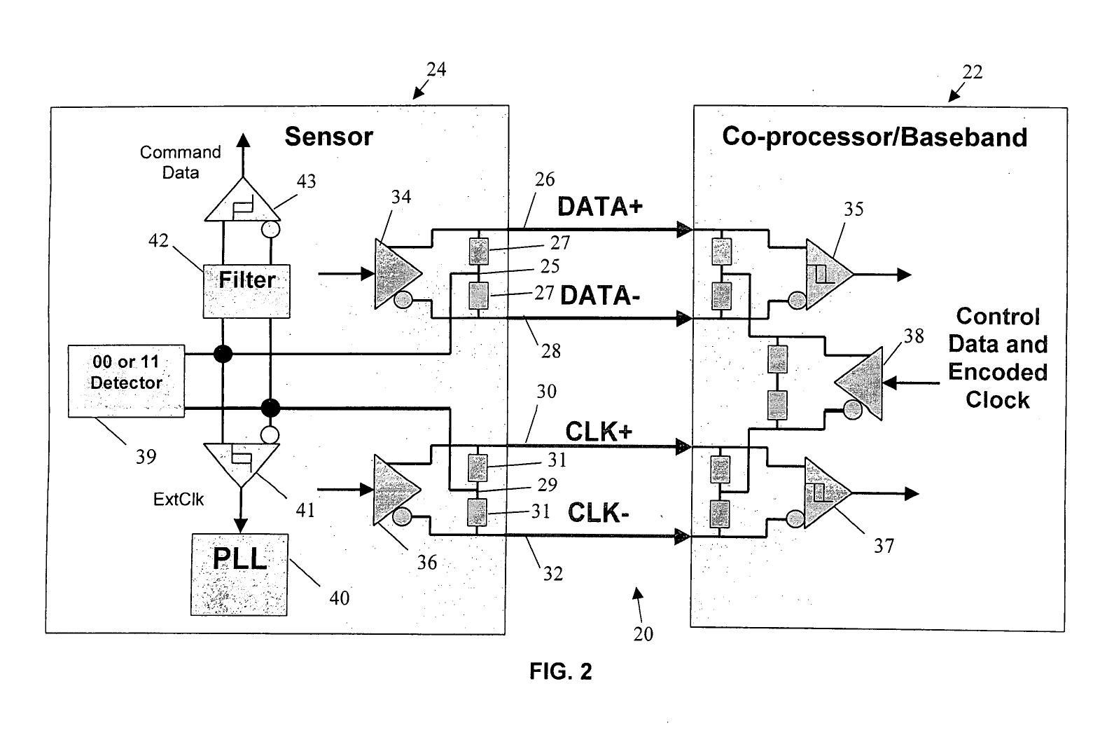

Referring to FIG. 2, a data communication system 20 is used between a first control device 22, or coprocessor, and a second data device 24, or sensor. Serial communication between the sensor 24 and the coprocessor 22 comprises a first transmission link, which in this case is a data communication link having a positive data line 26 and a negative data line 28, and a second transmission link, which in this case is a clock communication link having a positive clock line 30 and a negative clock line 32.

The sensor 24 has a data link driver 34 and clock link driver 36 to enable serial data transfer from the sensor 24 to the coprocessor 22. The coprocessor 22 has a data link receiver 35 and clock link receiver 37 which enable the information from the data communication link and the clock communication link to be utilized by the coprocessor 22. In prior art systems the serial data transfer has been only one way from the sensor 24 to the coprocessor 22.

The data communication link and clock communication link use differential signaling to transmit data bits and clock pulses respectively. Typically, a differential signal has two equal but opposite signals about a center potential. The center potential is often referred to as the common mode level V_{cm}. Therefore, the data communication link has a data common mode level and the clock communication link has a clock common mode level.

The coprocessor 22 has a control data driver 38 to create a control communication link between the coprocessor 22 and the sensor 24. The control driver 38 is connected to both the data communication link and the clock communication link. Control data information is transmitted to the sensor 24 from the coprocessor by creating a differential signal between the data communication link and the clock communication link by varying the data common mode level and the clock common mode level. The control data having a control common mode level representing the center potential of the control communication link. The data common mode level is detected at a common mode node 25 and the clock common mode level is detected at a common mode node 29. The node 25 is connected to the positive data line 26 and negative data line 28 by way of resistance elements 27. The node 29 is connected to the positive clock line 30 and negative clock line 32 by way of resistance elements 31. Typically, the resistance elements 27, 31 are of equal resistance.

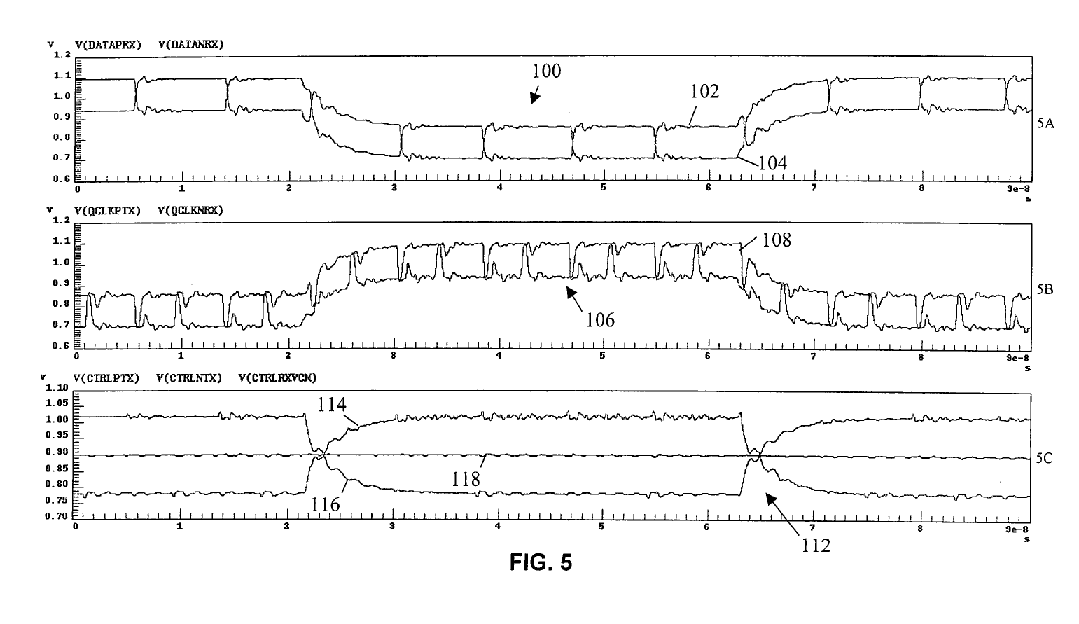

Referring to FIG. 5a, a data communication signal 100 is shown having a positive data signal 102 and negative data signal 104. Negative is only used in the sense that a signal is equal but opposite around a common mode level. The data communication signal 100 has a data common mode level at point 0 of approximately 1V and therefore the positive data signal 102 and negative data signal 104 will alternate above and below the data common mode level by the same amount. The exact timing of the positive data signal 102 and negative data signal 104 changes depending on the signal that is being transmitted.

FIG. 5b shows a clock communication signal 106 having a positive clock signal 108 and negative clock signal 110. The clock communication signal 106, at point 0, has a clock common mode level of approximately 0.78V and therefore the positive clock signal 108 and negative clock signal 110 will alternate above and below the clock common mode level by the same amount. FIG. 5c shows a control communication link 112 having a positive control signal 114 and a negative control signal 116. The positive control signal 114 is actually the clock common mode level and negative control signal 116 is actually the data common mode level. The control communication link 112 effectively has a control common mode level 118 about which the data common mode level and the clock common mode level alternate.

The control data includes an encoded control clock signal as well as control commands for the sensor 24 as described below. The control commands can comprise any control information that is required to operate the sensor 24 such as, for example, in the case of an image sensor, a capture image command. It is also possible to include device enable and/or power down commands which are functions that are often assigned a separate pin on an IC device. In a preferred embodiment, the device, in this case the sensor 22, is enabled and/or disabled by setting both the data common mode level and clock common mode level equal to ground. A device enable detector 39 receives the control data and detects device enable and/or power down commands.

The control clock signal is received by a control clock signal receiver 41 from the control data and passed to a Phase Lock Loop (PLL) 40. The PLL 40 enables the sensor 24 to provide a sensor clock signal which is of greater frequency than the control clock signal for transmission of sensor data across the serial communication link.

In this embodiment, by way of example only, the data communication system operates three separate clock frequencies for transfer of data. The external clock signal operates at 10 MHz, the control clock signal at 1 MHz and the sensor clock signal, for transfer of data from the sensor, at 100 MHz. The sensor 24 also includes a filter 42, discussed in more detail below, for filtering the control data before passing the control data to a control data receiver 43, which then provides a suitable control signal. In this embodiment, the control clock receiver 41 and the control data receiver 43 are first and second detector means enabled to detect differences in voltage levels between the first transmission link and the second transmission link.

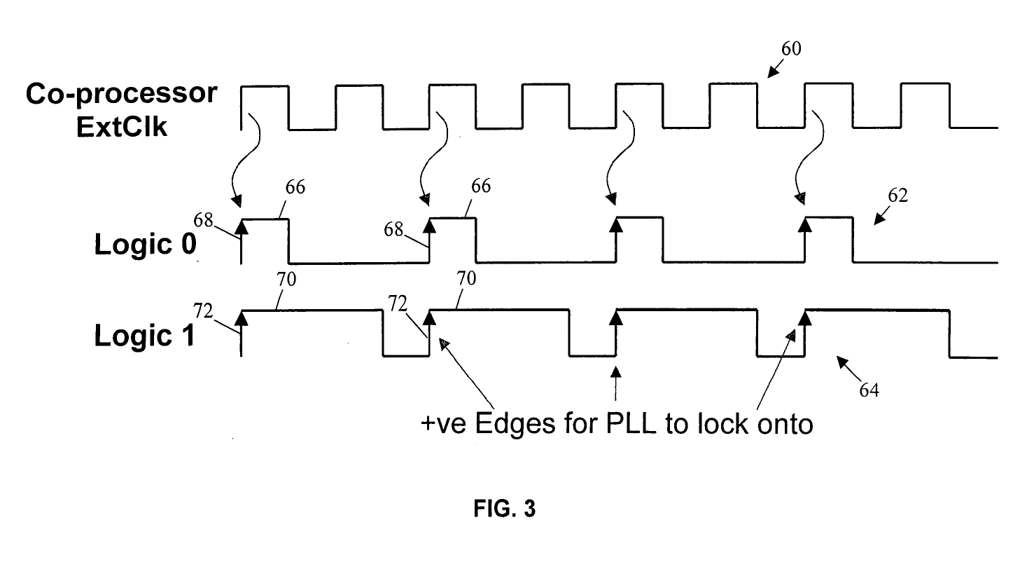

Referring now to FIG. 3, an external clock signal 60, a control logic “0” signal 62 and a control logic “1” signal 64 are shown. A control clock signal is transmitted across the control communication link by providing a control clock pulse 66, 70. The control clock signal is detected by the positive edge 68, 72 of the control clock pulse 66, 70. In this example, control data is transmitted over the control communication link at half the frequency of the external clock signal 60. To represent a logic “0” a short control clock pulse 66 is transmitted, equivalent to a single clock pulse of the external clock. To represent a logic “1” the duty cycle of the control clock pulse is altered to produce a long control clock pulse 70. By transmitting the control data in this manner a control clock signal can be sent encoded within the control data.

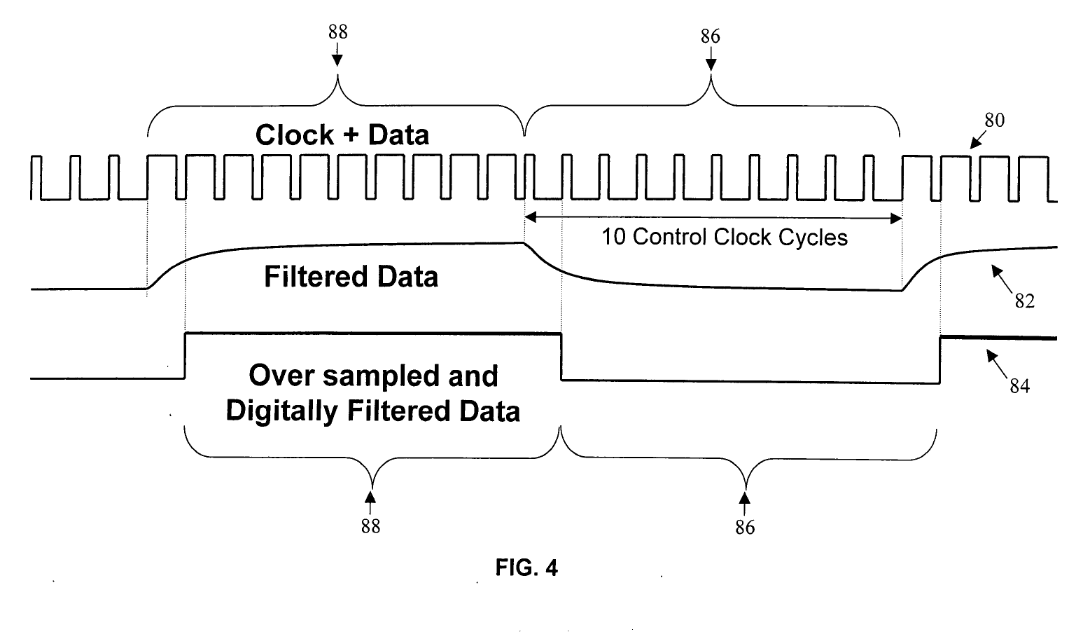

Referring now to FIG. 4, a control data signal 80, a filtered control data signal 82 and a digital control data signal 84 is shown. In this example, a logic “0” 86 or a logic “1” 88 is represented by ten control clock pulses in the control data signal 80. Therefore, if the external clock signal is 10 MHz, the control clock signal will be 1 MHz. The filter 42 has a number of filtering operations to produce the digital control data signal 84. Firstly, the control data signal 80 is low-pass filtered to produce the filtered control data signal 82. Secondly, the filtered control data signal 82 is over-sampled and digitally filtered to produce the digital control data signal 84.

It should be appreciated that, although the system has been described in relation to a differential data link and a differential clock link, any two differential links, regardless of the information they carry, would be appropriate to facilitate the invention. The present invention avoids the use of at least four pins on a typical prior art sensor while enabling bi-directional communication. These include two pins usually used as a private I²C bus for control commands from the coprocessor, a pin for the external clock and a pin for chip enable. Furthermore, the present invention is simple to implement and reduces cost as the amount of silicon area required is reduced. Improvements and modifications may be incorporated without departing from the scope of the present invention.

1-16. (canceled)

17. A data communication system comprising:
a control device;
a data device;
a communication link between the data device and the control device, and comprising a first transmission link and a second transmission link;
a data driver to transmit data from the data device to the control device across the communication link;
a differential controller to generate a voltage differential between the first transmission link and the second transmission link; and
a detector to detect differences in voltage levels between the first transmission link and the second transmission link.

18. The system as claimed in claim 17, wherein the control device receives an external clock signal and the differential controller varies the voltage differential between the first transmission link and the second transmission link such that the external clock signal is transmitted to the data device as an internal clock signal.

19. The system as claimed in claim 18, wherein the differential controller varies a duty cycle of the transmission of the internal clock signal to represent a data signal from the control device to the data device.

20. The system as claimed in claim 19, wherein the detector comprises a clock detector and a data detector.

21. The system as claimed in claim 20, wherein the data device further comprises a phase lock loop which receives the internal clock signal from the clock detector.

22. The system as claimed in claim 21, wherein the phase lock loop locks to positive edges of the internal clock signal.

23. The system as claimed in claim 17, wherein the first transmission link comprises a first data line and a second data line, and the second transmission link comprises a first clock line and a second clock line, the first and second transmission links thereby forming a serial data link from the data device to the control device, the first transmission link thereby having a first common mode voltage and the second transmission link having a second common mode voltage.

24. The system as claimed in claim 18, wherein the data device further comprises a filter to filter the internal clock signal to extract the data signal from the internal clock signal and produce a filtered data signal.

25. The system as claimed in claim 24, wherein the filter comprises an analog filter, an over-sampler and a digital filter, the data signal first being passed to the analog filter before being over-sampled by the over-sampler and finally digitally filtered by the digital filter to produce the filtered data signal.

26. A system as claimed in claim 17, wherein the data device is enabled/disabled based upon both the first and the second transmission links being set to one of a first and second logic state.

27. A system as claimed in claim 26, further comprising a device enable detector to detect that the logic state on the first and the second transmission links, and enable/disable the data device based thereon.

28. An electronic device comprising:
a data communication system including
a control device,
a data device,
a communication link between the data device and the control device, and comprising a first transmission link and a second transmission link,
a data driver to transmit data from the data device to the control device across the communication link,
a differential controller to generate a voltage differential between the first transmission link and the second transmission link, and
a detector to detect differences in voltage levels between the first transmission link and the second transmission link.

29. The electronic device as claimed in claim 28, wherein the electronic device is an optical pointing device.

30. The electronic device as claimed in claim 29, wherein the optical pointing device is an optical mouse.

31. The electronic device as claimed in claim 28, wherein the electronic device is a mobile electronic device.

32. The electronic device as claimed in claim 31, wherein the mobile electronic device is a mobile cellular telephone.

33. The electronic device as claimed in claim 31, wherein the mobile electronic device is a camera.

34. A method of data communication between a control device and a data device, the method comprising:
providing a communication link between the data device and the control device, and comprising a first transmission link and a second transmission link;
transmitting data from the data device to the control device across the communication link;
generating a voltage differential between the first transmission link and the second transmission link; and
detecting differences in voltage levels between the first transmission link and the second transmission link.

35. The method as claimed in claim 34, further comprising:
providing the control device with an external clock signal; and
varying the voltage differential between the first transmission link and the second transmission link such that the external clock signal is transmitted to the data device as an internal clock signal.

36. The method as claimed in claim 34, wherein the first transmission link comprises a first data line and a second data line, and the second transmission link comprises a first clock line and a second clock line, the first and second transmission links thereby forming a serial data link from the data device to the control device, the first transmission link thereby having a first common mode voltage and the second transmission link having a second common mode voltage.
